(19) United States
(12) Patent Application Publication
(10) Pub. No.: US 2009/0225007 A1
(43) Pub. Date: Sep. 10, 2009

(54) DRIVING METHOD OF PLASMA DISPLAY PANEL AND PLASMA DISPLAY APPARATUS

(76) Inventors: Junichi Kumagai, Kunitomi (JP); Masayuki Shibata, Kunitomi (JP); Takashi Sasaki, Kunitomi (JP)

Correspondence Address: MATTINGLY & MALUR, P.C., 1800 DIAGONAL ROAD, SUITE 370, ALEXANDRIA, VA, 22314, US

(21) Appl. No.: 12/093,078

(22) PCT Filed: Feb. 1, 2006
(86) PCT No.: PCT/JP2006/301659

§ 371 Date: May 8, 2008

(51) Int. Cl. G09G 3/28

(52) U.S. Cl. 345/60

(57) ABSTRACT

A driving method of a PDP which discharges between respective adjacent display electrodes, wherein wasteful light emission caused by inefficiency of reset operation is reduced. The driving method being provided with a lattice shaped rib and an interlace driving method. By driving waveforms to respective display electrodes, the reset operation is performed to only one of odd-numbered and even-numbered display lines according to interlace driving of adjacent even-numbered and odd-numbered display lines. A pair of display electrodes of the other of the even-numbered and odd-numbered display lines being a non-objective of the reset operation, potential difference thereof is set to be 0 or smaller than a discharge starting voltage. In an odd-numbered field, the even-numbered display line is reset, and in an even-numbered field, the odd-numbered display line is reset.

### TECHNICAL FIELD

The present invention relates to a driving method of a plasma display panel (PDP) and a display apparatus (plasma display apparatus: PDP apparatus) displaying moving image on the PDP, in particular, to reset operation at driving the PDP.

### BACKGROUND ART

At present, the PDP apparatuses are used in practice as flat displays, and are expected as thin displays with high luminance. In the present PDP apparatuses, as structures concerning electrodes in the PDP, there are a general structure (referred to as a first structure) and a structure different therefrom (referred to as a second structure) described below. The first structure is a structure in which one display line (referred to as a row) is formed by a pair of two display electrodes (for example, shown by symbols (X, Y)) extending in a horizontal (first) direction, and the display line is repeated in a vertical (second) direction. The second structure is a structure in which the display electrodes (X, Y) extending in the horizontal direction are repeated alternately in the vertical direction in the same manner, and display lines are formed between all the adjacent display electrodes (this corresponds to a so-called ALIS structure). The second structure is, in other words, an electrode arrangement structure in which the adjacent two display lines (that is, three display electrodes) share one display electrode intermediate thereof.

The second structure, in comparison with the first structure, can realize about twice the number of display lines, if the number of display electrodes is same in the PDP. If the same number of display lines is to be formed, it can be realized by about half the number of display electrodes. A detailed structure and operation of a PDP apparatus according to the second structure are disclosed in Japanese Patent No. 3424587 (Patent Document 1), and therefore, detailed explanation thereof is omitted herein.

And, at present, as a structure concerning a barrier rib (rib) in the PDP apparatus, in the PDP apparatus according to the second structure, there are a first rib structure and a second rib structure described below. The first rib structure is a structure in which the barrier rib (stripe shaped rib) is provided in the vertical direction in parallel with address electrodes between the address electrodes provided so as to extend in the vertical direction. The second rib structure is a structure in which the barrier rib is provided also in the horizontal direction so as to divide each display electrode into two pieces in the vertical direction, and by a barrier rib (lattice shaped rib) composed of combination of the barrier rib in the horizontal direction and the above barrier rib in the vertical direction, each display cell is separated in a lattice pattern.

In the first rib structure, since the barrier rib in the horizontal direction is not provided between the display electrodes, discharge at the display cell expands over the whole two display electrodes in an area between the barrier ribs in the vertical direction. In this structure, an area of the discharge is wide, and therefore, influence of electric charges may spread to adjacent display lines.

On the other hand, in the second rib structure, in discharge at the display cell, since no electric charge spreads over a range of each display cell sectioned by the vertical and horizontal barrier ribs in the lattice pattern, a voltage applied between two display electrodes for driving the display lines can be made large. Further, since each display cell has four barrier rib surfaces on which phosphor is applied, luminous efficiency is excellent. A detailed structure and operation of a PDP apparatus provided with the second rib structure are disclosed in Japanese Patent No. 3485874 (Patent Document 2), and therefore, detailed explanation thereof is omitted herein.

And, there is a technique of a PDP in which the following wall charge control by reset in two stages is employed in a driving sequence when performing display using an interlace driving method (driving odd-numbered and even-numbered display lines alternately in terms of time) as a PDP driving method in the PDP apparatus of the second structure, and the technique is disclosed in Japanese Patent Application Laid-Open Publication No. 2004-85693 (Patent Document 3). In this technique, wall charge control of the two stages is employed in the driving sequence. In the wall charge control, as reset operation preparing addressing or a part of the reset operation, reset discharge is caused only in display lines used for displaying in the sustain (sustain discharge) just before, and then, reset discharge is caused only in the other display lines In this control operation, the wall charge is reduced in the reset discharge of the first stage. However, if the charge has bias at start of the discharge, the bias of the charge is left more or less even after completion of the discharge. Therefore, if a cell in which discharge occurs is a cell between a cell with excessive positive charge and a cell with excessive negative charge, the excessive charges neutralize each other by the reset discharge of the second stage and the bias of the charge is reduced.

### DISCLOSURE OF THE INVENTION

### Problems to be Solved by the Invention

In the second structure, if a voltage is applied to one display electrode, influence (spread of charges of the discharge) works on both the display lines and the cells by the two display electrodes adjacent thereto. Thereby, in particular, in the reset operation, the reset operation is performed also to non-lighting objective cells, and accordingly, inefficiency caused by wasteful light emission occurs. This inefficiency of the reset operation leads to contrast decrease irrespective of a display state.

The present invention is made in view of the above problem, and an object of the present invention is to provide a driving method of a PDP having the structure (second structure) capable of discharging between the respective adjacent display electrodes and a PDP apparatus employing the driving method, thereby providing a technique solving problems such as increase of background luminance by wasteful light emission of non-lighting objective display lines and cells caused by the reset operation influencing the adjacent display electrodes and both of the display lines and cells and contrast decrease of the PDP caused thereby.

The typical ones of the inventions disclosed in this application will be briefly described as follows. In order to achieve the above object, the present invention has the following technical means in the structure (second structure) capable of discharging between the respective adjacent display electrodes, the lattice shaped rib structure (second rib structure), and a PDP driving method as well as a PDP apparatus employing the interlace driving method.

In the second structure, in the present PDP driving method, in adjacent two display lines (in other words, an odd-numbered display line and an even-numbered display line) by the display electrodes adjacent in the vertical direction with respect to one display electrode, in order to reset a display cell of the display line at one side, the operation of reset discharge is carried out only to the display line of relevant one side. In other words, a voltage pulse (drive waveform in a reset period) is applied from a drive circuit side. The voltage pulse has a characteristic which causes the reset discharge in only the display line of one side of odd-numbered and even-numbered including lighting objective display cells to be a driving objective in the interlace driving and causes no reset discharge in a display line of the other side. The reset (reset discharge) is discharge of charge adjustment for preparation of addressing (address operation) in a display unit such as a subfield (SF) structure.

For example, in operation of driving and control in the reset period in each SF in a field of the PDP, a pulse is applied from the drive circuit side. The pulse lights and displays the odd-numbered and even-numbered display lines alternately and causes the reset discharge with respect to each display electrodes pair of one side of odd-numbered and even-numbered for each of odd-numbered and even-numbered fields. Thereby, wasteful light emission in the display line including the non-lighting objective display cells is eliminated or reduced, and the background luminance is decreased.

To the reset non-objective display line, a voltage pulse in which no reset discharge between the relevant electrodes is generated in the objective display electrode pair is applied, that is, the same or similar waveform is applied so that the relevant electrode pair has the same potential or voltage smaller than a discharge starting voltage.

In the PDP of the present PDP apparatus, structures of respective display electrodes to perform functions such as scan (y) and sustain (x) are provided in correspondence to the driving method of the PDP. And, in the present PDP apparatus, a circuit such as a drive circuit for driving and controlling electrodes of the PDP is provided.

Further, in the driving method of the PDP, using the control of the reset operation (first type reset operation) as a basis, an on-cell reset operation (second type reset operation) thinning out a part of a waveform in the reset period made by combining operation control in a sustain period just before the reset period can be performed. In this operation, at the vicinity of the end of the sustain period, a pulse adjusting charges so as to thin out a pulse in a first period within the next reset period is applied.

And, in the driving method of the PDP, for example, a wall charge control of two stages in operation of the reset period is carried out, and in correspondence thereto, other display lines in plural odd-numbered and even-numbered display lines are reset sequentially.

The present PDP apparatus has a following configuration, for example. A group of display electrodes arranged in parallel so as to extend in a first direction over a first plate and having discharge gaps formed between the electrodes adjacent at both sides in a second direction perpendicular to the first direction respectively and a dielectric layer and a protective layer covering the group of display electrodes are provided. A group of address electrodes arranged over a second plate opposing the first plate so as to intersect with the group of display electrodes, a dielectric layer covering the group of address electrodes, second barrier ribs arranged at both sides of the group of address electrodes and extending in the second direction, first barrier ribs extending in the first direction so as to overlap with the display electrodes and phosphor applied to a region between the first and the second barrier ribs are provided. The PDP is configured by sticking the first plate and the second plate together, display lines are formed by pairs of the display electrodes adjacent to each other and a display cell is formed in a region of intersection of the pair of the display electrodes and the address electrodes surrounded by the first and the second barrier ribs in a lattice shape. In the method of driving the PDP, an interlace driving method lighting and displaying one of the odd-numbered and even-numbered display lines alternately by a field of the PDP is used. The pair of the display electrodes of one of the odd-numbered and the even-numbered display lines to be an objective of the lighting and displaying is taken as an objective, reset operation to be preparation operation for addressing is performed by a driving waveform from a side of a drive circuit.

The effects obtained by typical aspects of the present invention will be briefly described below. According to the present invention, the wasteful light emission in the non-lighting objective display lines can be eliminated or reduced, and therefore, the background luminance can be reduced, and as a result, contrast of a PDP can be improved.

### BRIEF DESCRIPTIONS OF THE DRAWINGS

FIG. 1 is a diagram showing a driving waveform of an odd-numbered field (Fo) in a PDP driving method and a PDP apparatus according to a first embodiment of the present invention;

FIG. 2 is a diagram showing a driving waveform of an even-numbered field (Fe) in the PDP driving method and the PDP apparatus according to the first embodiment of the present invention;

FIG. 3 is a perspective view showing a disassembled structure of a PDP in the PDP apparatus according to an embodiment of the present invention;

FIG. 4 is a cross sectional view of the PDP in the PDP apparatus according to the embodiment of the present invention in a vertical (second) direction;

FIG. 5 is a diagram showing a structure of a field of the PDP in the PDP apparatus according to the embodiment of the present invention;

FIG. 6 is a diagram showing display lines to be lighting objectives and reset objectives in each field in an interlace driving method, and a reset timing (objective subfield), in the PDP driving method and the PDP apparatus according to the first embodiment of the present invention;

FIG. 7 is a diagram showing schematic structures of electrodes and circuits in the PDP apparatus according to the first embodiment of the present invention;

FIG. 8 is a diagram showing roles (functions) of circuits and electrodes in the PDP apparatus according to the first embodiment of the present invention;

FIG. 9 is a diagram showing a driving waveform of an odd-numbered field (Fo) in a PDP driving method and a PDP apparatus according to a second embodiment of the present invention;

FIG. 10 is a diagram showing a driving waveform of an even-numbered field (Fe) in the PDP driving method and the PDP apparatus according to the second embodiment of the present invention;

FIG. 11 is a diagram showing display lines to be lighting objectives and reset objectives in each field in the interlace driving method, and a reset (normal reset) timing and an on-cell reset timing (objective subfield) in the PDP driving method and the PDP apparatus according to the second embodiment of the present invention;

FIG. 12 is a diagram showing schematic structures of electrodes and circuits in a PDP driving method and a PDP apparatus according to a third embodiment of the present invention;

FIG. 13 is a diagram showing a driving waveform of an odd-numbered field (Fo) in the PDP driving method and the PDP apparatus according to the third embodiment of the present invention;

FIG. 14 is a diagram showing a driving waveform of an even-numbered field (Fe) in the PDP driving method and the PDP apparatus according to the third embodiment of the present invention;

FIG. 15 is a diagram showing display lines to be lighting objectives and reset objectives in each field in the interlace driving method, and a reset timing (objective sub-fields and period) in the PDP driving method and the PDP apparatus according to the third embodiment of the present invention;

FIG. 16 is a diagram showing a driving waveform of an odd-numbered field (Fo) in a PDP driving method and a PDP apparatus according to a fourth embodiment of the present invention; and

FIG. 17 is a diagram showing a driving waveform of an even-numbered field (Fe) in the PDP driving method and the PDP apparatus according to the fourth embodiment of the present invention.

### BEST MODE FOR CARRYING OUT THE INVENTION

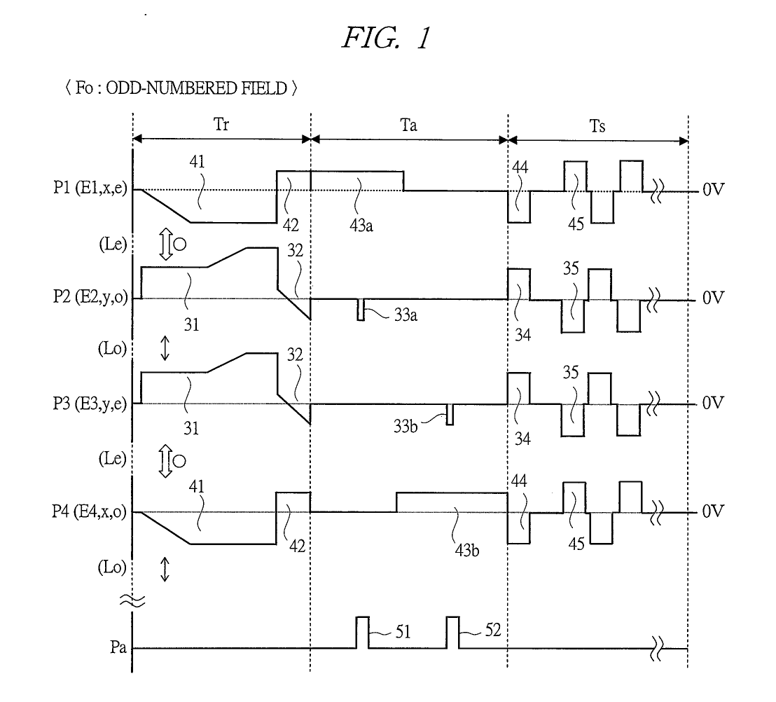

Hereinafter, embodiments of the present invention will be described in detail with reference to the accompanying drawings. Note that the same components are denoted by the same reference symbols throughout the drawings for describing the embodiment, and the repetitive description thereof will be omitted. FIG. 1 to FIG. 17 are drawings for explanation of embodiments of the present invention.

### First Embodiment

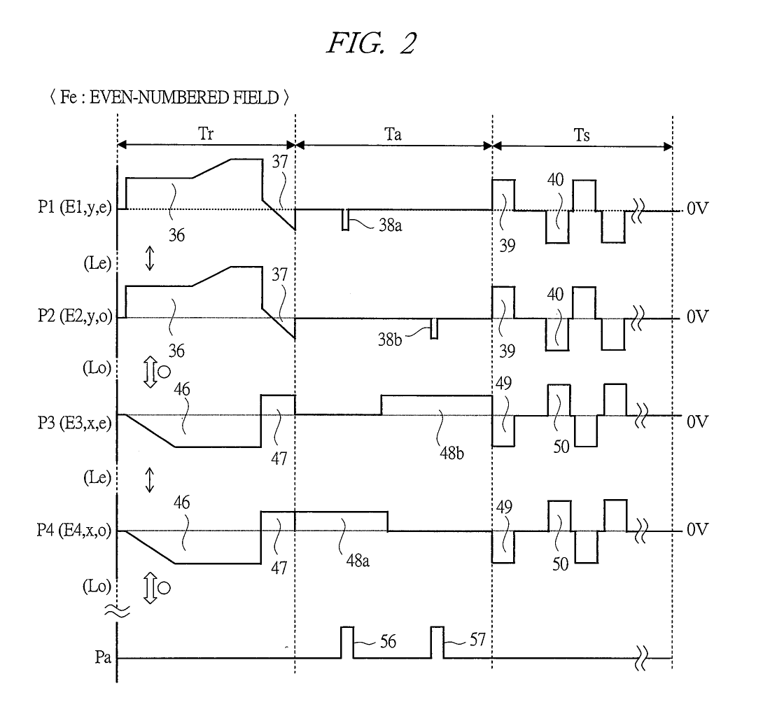

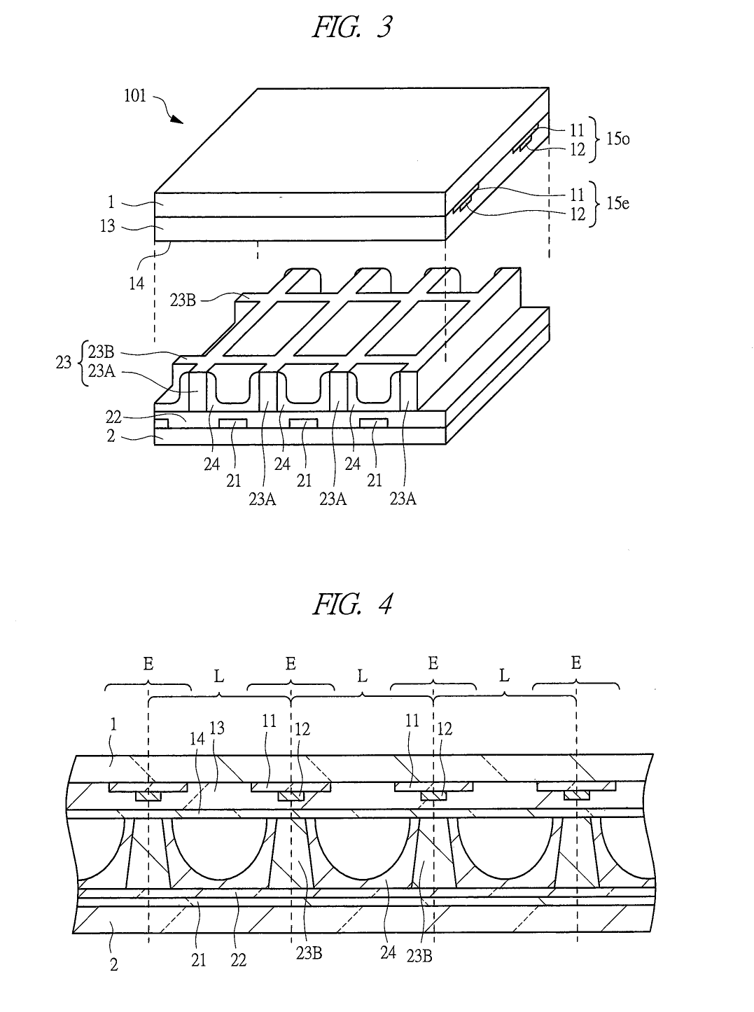

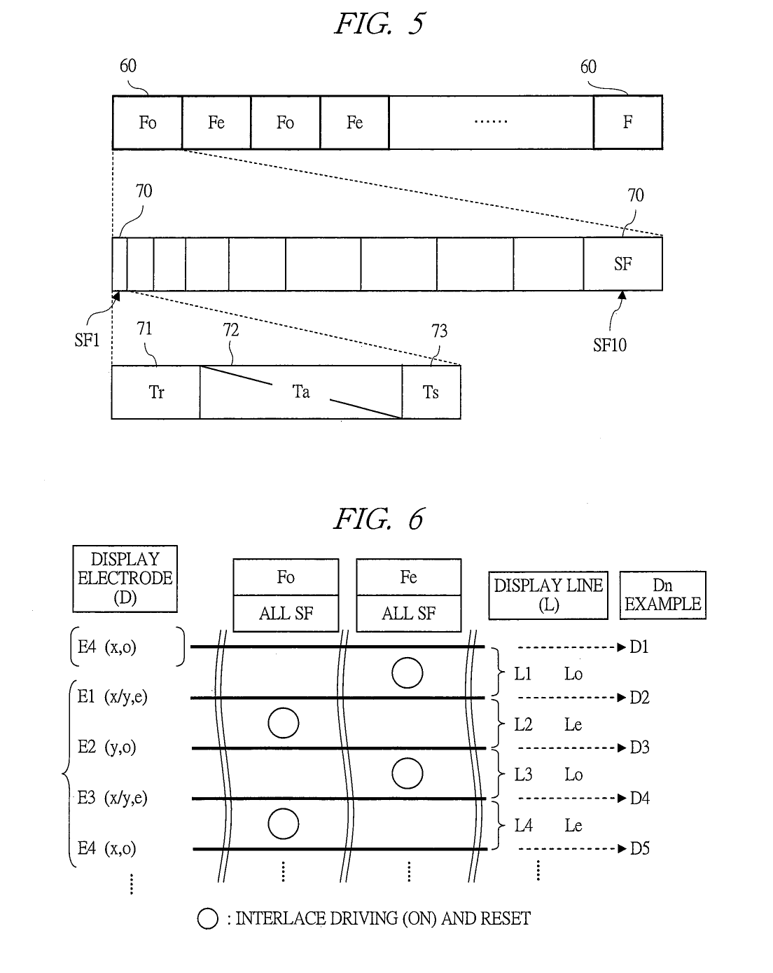

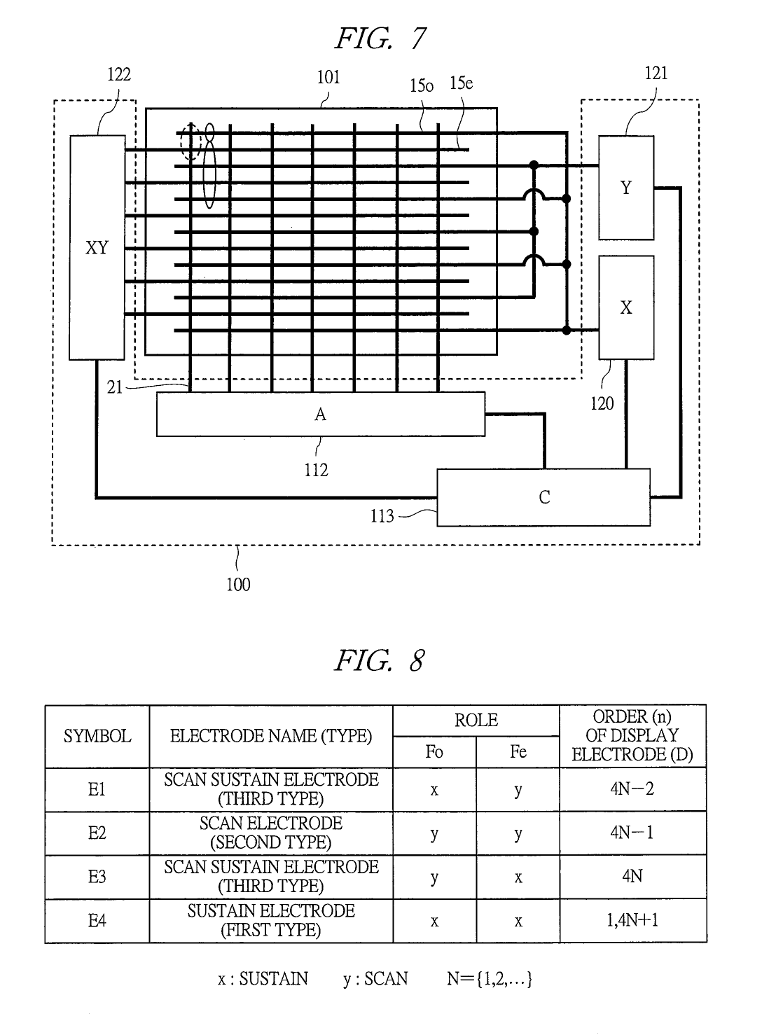

Hereinafter, a first embodiment according to the present invention is explained with reference to FIG. 1 to FIG. 8. FIG. 1 and FIG. 2 show characteristic driving waveforms. FIG. 3 shows a schematic structure in unit of pixel of a PDP (panel) 101. FIG. 4 shows a cross sectional view of the PDP 101 in FIG. 3 along an address electrode 21. FIG. 4 shows a screen structure corresponding to an interlace driving method. FIG. 5 shows a driving format of the PDP 101. FIG. 6 shows a schematic structure of a PDP apparatus comprising electrodes (only part thereof) of the PDP 101 and circuits (drive circuit and control circuit) connected therewith. FIG. 7 shows types and roles of each display electrode (E) and the like.

The first embodiment has a feature that, as a driving method of the PDP 101 and the PDP apparatus thereof utilizing a second structure in which discharge can be made between all adjacent display electrodes (E), the lattice shaped rib structure and the interlace driving method, in correspondence to alternative display driving of odd-numbered and even-numbered display lines (Lo, Le) for each odd-numbered (o) and even-numbered (e) fields 70 (Fo, Fe) in the interlace driving method, by application of a driving waveform to respective display electrodes (E), reset discharge is carried out to only one side of the odd-numbered and even-numbered display lines (Lo, Le), and the reset discharge is not carried out to the other side.

### <Apparatus Structure>

In FIG. 3, the PDP 101 is structured by combining a front plate 1 and a back plate 2 made mainly of glass. In the front plate 1 on a display side, plural pairs of transparent electrodes 11 and metal electrodes (referred to also as bus electrodes) 12 extending in the horizontal (first) direction are formed, and over the pairs, a dielectric layer 13 covering these electrodes and a protective layer 14 made of magnesium are provided. In electrodes structured of the transparent electrodes 11 and the metal electrodes 12 (herein, referred to as display electrodes, and denoted by symbols E and D), odd-numbered ones (Eo) are referred to also as odd-numbered electrodes 150, and even-numbered ones (Ee) are referred to as even-numbered electrodes 15e. The transparent electrodes 11 and the metal electrodes 12 are electrically connected. Plural odd-numbered electrodes 150 and even-numbered electrodes 15e are arranged in parallel and adjacent, in the vertical (second) direction, alternately at the same intervals.

Further, in the back plate 2 positioned in a side opposing the front plate 1, plural address electrodes 21 extending in the vertical direction are arranged so as to intersect with the display electrodes (E) composed of the odd-numbered electrodes 150 and the even-numbered electrodes 15e. Over the address electrodes 21, in the same manner as the front plate 1 side, a dielectric layer 22 is formed, and over the dielectric layer 22 further, a lattice shaped barrier rib 23 is formed. Thereby, discharge space is sectioned in correspondence to the display cells. The barrier rib 23 is structured of vertical barrier ribs 23A at both sides of the address electrodes 21, and horizontal barrier ribs 23B formed so as to position just under the metal electrodes 12. And, the transparent electrodes 11 are formed to expand over cells at both sides across the horizontal barrier ribs 23B, and accordingly, if a voltage is applied to one display electrode (the metal electrode 12 connected at a drive circuit side), influence works to both display cells adjacent in upper and lower in the vertical direction.

Over the dielectric layers 22 sectioned by the barrier ribs 23, phosphors 24 of respective colors of R (red), G (green), and B (blue) are formed distinctly. The phosphors 24 are applied so as to cover regions inside the display cell, that is, over the dielectric layer 22 between the barrier ribs 23 and four respective side surfaces of the barrier ribs 23. The front plate 1 and the back plate 2 structured as above are stuck together, and discharge gas of Ne, Xe or the like is encapsulated, and thereby the PDP 101 is formed.

In FIG. 4, as electrode arrangement, a structure (second structure) in which two adjacent display lines (shown by L), that is, two adjacent display cells and display lines (L) in a set of three display electrode, share one display electrode (E) (especially the transparent electrode 11) is provided. A width of the transparent electrode 11 is larger than a width of the metal electrode 12, edges thereof protrude to inside of the cell, and a gap for discharge is formed. By the horizontal barrier ribs 23B, the metal electrodes 12 are positioned above the same, and the transparent electrodes 11 are functionally separated. Since the respective display cells exist independently by the lattice shaped barrier ribs 23 in the PDP 101, display lines are formed in all positions between (in pairs of) the adjacent display electrodes (E). With the same number of display electrodes (E), about twice the number of display lines (L) can be realized. In the PDP apparatus of the second structure, in order to obtain 2N pieces of display lines (L), (N+1) pieces of odd-numbered electrodes 150 and N pieces of even-numbered electrodes 15e are required.

### <Field Structure>

In FIG. 5, one field (denoted by F, and referred to also as frame) 60 corresponding to one screen of the PDP 101 is composed of plural subfields (SFs) 70 with different weighting with respect to a sustain period (Ts) 73, for example, 10 pieces of SFs 70 “SF1” to “SF10”. By combining SFs to be lighted at the field 60, grey scale is expressed. In the interlace driving method, odd-numbered fields (Fo) and even-numbered fields (Fe) in plural fields 60 are driving-controlled alternately.

Each SF 70 has a rest period (Tr) 71, an address period (Ta) 72 and a sustain period (Ts) 73. The Tr 71 is a period corresponding to reset operation for equalizing wall charges of display cells as preparation of addressing. The Ta 72 is a period corresponding to the addressing generating discharge selecting display cells to be lighted and forming wall charges in the display cells. The Ts 73 is a period corresponding to sustain operation generating display discharge only in the display cells to be lighted utilizing the wall charges.

In the PDP apparatus, the PDP 101 of a dot matrix type and an AC type is driven and controlled by the interlace driving method, and accordingly, in the odd-numbered fields (Fo), odd-numbered display lines (Lo) are displayed (lighted), and in the even-numbered fields (Fe), even-numbered display lines (Le) are displayed.

### <Interlace Driving Method>

In FIG. 6, display cells and lines emitting light in F and SF in driving by the interlace driving method, and, lines normally reset in correspondence thereto are shown by circles (°). First, the interlace driving method is briefly explained. Then, the driving method aimed at the reset operation in the first embodiment is explained.

In a case of the interlace driving as shown in FIG. 6, in Fo, even-numbered display lines (Le) are driving objectives, and in Fe, odd-numbered display lines (Lo) are driving objectives. That is, in Fo (all SFs 70), for example, a display cell of a display line (L2) by a first display electrode (E1) and a second display electrode (E2) and a display cell of a display line (L4) by a third display electrode (E3) and a fourth display electrode (E4) emit light. And, in Fe (all SFs 70), for example, a display cell of a display line (L1) by the fourth display electrode (E4) and the first display electrode (E1) and a display cell of a display line (L3) by the second display electrode (E2) and the third display electrode (E3) emit light. Note that, if a plural display lines (L) of a whole field 60 of the PDP 101 are defined as Lm, L1 and L3 are odd-numbered (o) lines, and L2, L4 are even-numbered (e) lines, for example.

Note that, the interlace driving in FIG. 6 functions also in an embodiment in which odd and even of driving objectives are reversed in Fo, Fe.

However, in a PDP having a structure in which respective display cells in adjacent two (that is, odd-numbered and even-numbered) display lines share one intermediate display electrode, like the second structure of the conventional art, if waveforms for carrying out the reset discharge are inputted to the display electrodes, the inputted waveforms are shared by these adjacent display lines and cells in the structure, and therefore, reset discharge occurs also in display cells in which the reset discharge is unnecessary.

Therefore, the present embodiment is applied. That is, in the PDP 101 according to the first embodiment, in correspondence to the display lines (L) to be driven by the interlace driving method in FIG. 6, normally, reset discharge (circles) is caused in only one side of odd-numbered and even-numbered display lines (Lo/Le), that is, reset discharge is not caused in the other side of the display lines (L). In the first embodiment, reset is preformed, aimed at all the SFs 70, separately to Fe, Fo in formats shown in FIG. 6 and FIG. 8.

### <Circuit Structure (1)>

FIG. 7 shows the PDP apparatus according to the first embodiment in which the PDP 101 is a panel of a dot matrix type and surface discharge type having the structure shown in FIG. 3. Regions in which odd-numbered and even-numbered display electrodes (150, 15e) and an address electrode 21 intersect with each other correspond to display cells. The PDP apparatus differs from the conventional structure in a circuit structure and a structure of role of display electrode corresponding thereto.

As a circuit structure, a circuit unit (drive unit) 100 of the present PDP apparatus includes a control circuit (C) 113, an address drive circuit (A) 112, a sustain circuit (X) 120, a scan circuit (Y) 121 and a scan sustain circuit (XY) 122. The control circuit (C) 113 performs total control including control to the respective drive circuits (drivers) {112, 120, 121, 122}. The respective drive circuits generate and output drive waveforms for driving corresponding electrodes of the PDP 101, according to a control signal, display data and the like from the control circuit 113. The address drive circuit 112 is a drive circuit for applying a voltage for addressing to a group of address electrodes 21.

The scan circuit 121 is a drive circuit electrically connected to a group of second display electrodes (E2) of the PDP 101 for applying voltages for driving these electrodes so as to play roles as scan (y) electrodes always. The sustain circuit 120 is a drive circuit electrically connected to a group of fourth display electrodes (E4) of the PDP 101 for applying voltages for driving these electrodes so as to play roles as sustain (x) electrodes always. The scan sustain circuit (XY) 122 is a drive circuit electrically connected to a group of first and third display electrodes (E1, E3) of the PDP 101 for applying voltages for driving these electrodes so as to play roles as scan (y) or sustain (x) electrodes, selectively according to Fo, Fe.

In plural display electrodes (E, Dn) in the PDP 101, display electrode groups (E1 to E4) structured of a set of four electrodes, that is, two electrodes (E1, E3) connected to the scan sustain circuit 122, one electrode (E2) connected to the scan circuit 121 and one electrode (E4) connected to the sustain circuit 120 are arranged repeatedly. Further, the PDP 101 includes a display electrode (E4) connected to the sustain circuit 120, as a first display electrode (D1), at a most upper portion of plural display lines (L) in order to form the display lines at both side of the scan (yy electrode.

In the first embodiment, as the roles of the display electrodes, the scan (y) is for applying a scan pulse at the address operation of the Ta 72, and the sustain (x) is for applying no scan pulse at the address operation.

### <Electrode Structure (1)>

In FIG. 8, operation of each display electrode (E) of the PDP 101 in the first embodiment is summarized. In the first to fourth display electrode (E1 to E4), the E1 and the E3 are the scan sustain electrodes (third type electrode: Exy), the E2 is the scan electrode (second type electrode: Ey) and the E4 is the sustain electrode (first type electrode: Ex). As for roles, the E4 is fixedly for sustain (x), the E2 is fixedly for scan (y) and the E1 and the E3 are selectively, for both (x/y) of scan (y) and sustain (x). In correspondence to FIG. 6, the E1 is driven to be x at Fo and y at Fe, and on the contrary, the E3 is driven to be y at Fo and x at Fe.

As order (n) of the whole plural display electrodes (Dn) in the PDP 101, by use of N={1, 2, . . . }, the E1 is expressed as (4N−2), and the E2 is expressed as (4N−1), the E3 is expressed as (4N), and E4 is expressed as (1, 4N+1). Note that, these can be expressed also as E3=4M.

In FIG. 6 in correspondence to FIG. 8, as the display electrodes (E), repetition of display electrode groups composed of a set of four electrodes, that is, E1 to E4 by three types of electrodes is provided. As shown in parentheses, the E1 and the E3 are for both of scan and sustain (x/y) and even numbers (e), the E2 is for scan (y) and odd number (o), and the E4 is for sustain (x) and odd number (o). As shown also in FIG. 7, in the view of total arrangement of the plural display electrodes (Dn) in the field 60 of the PDP 101, in order, a first display electrode (D1) corresponds to the E4, and in the same manner, the D2 corresponds to the E1, the D3 corresponds to the E2, the D4 corresponds to the E3, and the D5 corresponds to the E4, respectively. The sixth and later are repetition of the E1 to the E4, and the E4 is arranged at the end.

### <Driving Waveform (1)>

In FIG. 1 and FIG. 2, the driving method in the first embodiment is explained. Driving waveforms (P1 to P4) applied from respective drive circuit sides in correspondence to a group of display electrodes (the E1 to the E4) are shown. Lighting cells at each SF 70 by the driving waveforms (the P1 to the P4) are as shown in FIG. 6, and are the same at all the SFs 70, respectively in the Fe and the Fo. The display electrodes performing the sustain scan (x/y) are the E1 and the E3, the display electrode performing the scan (y) is the E2, and the display electrode performing the sustain (x) is the E4. For easy understanding, functions, states and the like are shown in parentheses of the P1 to the P4. For example, the P1 is a driving waveform for controlling for the sustain (x) as the role, to the E1 for both of scan and sustain (x/y) at even number (e). And, for making easy the display lines (L) to be reset, odd-numbered/even-numbered display lines (L) are shown in parentheses among the P1 to the P4. In correspondence thereto, in the Tr 71, a bold arrow with circle shows a reset discharge objective, and a thin arrow shows a non-reset discharge objective. The meanings of these marks are the same in other drawings.

To the E1 and the E3, the P1 and the P3 are applied from the scan sustain circuit 122 respectively, to the E2, the P2 is applied from the scan circuit 121, and to the E4, the P4 is applied from the sustain circuit 120. To the display electrode (D1) in the most upper part of the display line (L), the driving waveform (P4) of the E4 is applied. And, in the first embodiment, since the driving waveforms applied to respective SFs 70 of the respective fields 60 are basically the same, one example of a typical driving waveform in the Fo and the Fe in unit of one SF 70 is explained. Note that, the Pa is a driving waveform applied to the address electrode 21.

One SF 70 is, as shown in FIG. 5, structured of the reset period (Tr) 71 equalizing wall charges of cells as preparation of addressing, the address period (Ta) 72 forming a wall voltage between a cell to be lighted and other cells, and the sustain period (Ts) 73 generating display discharge in only the cell to be lighted utilizing difference of the wall voltages. Since the PDP 101 is driven and displayed by the interlace driving method, display image is structured of the Fo and the Fe.

In FIG. 1, in the Fo, according to FIG. 6, it is necessary to perform the reset discharge in the Tr 71 in order to light at the even-numbered display lines (Le) between E1-E2 and E3-E4. On the other hand, as for the odd-numbered display lines (Lo) between E2-E3 and E1-E4, it is not necessary to perform the reset discharge in the Tr 71 so as to light off. Therefore, the driving waveforms (the P1 to the P4) are waveforms causing the reset discharge between E1-E2 (L2) and between E3-E4 (L4), and, causing no reset discharge between E2-E3 (L3) and between E4-E1 (L1).

On the other hand, in FIG. 2, in the Fe, by the same scheme as in the Fo, the driving waveforms (the P1 to the P4) are designed so as to cause the reset discharge between E2-E3 (L3) and between E4-E1 (L1), and cause no reset discharge between E1-E2 (L2) and between E3-E4 (L4).

Herein, since the E1 and the E3 play both of roles of the sustain (x) and the scan (y) by switching the roles in the Fo and the Fe, potential is controlled from the sustain scan circuit 122. The E2 performs the role of the scan in both of the Fo and the Fe, and therefore, potential is controlled from the scan circuit 121. The E4 performs the role of the sustain in both of the Fo and the Fe, differently from the E2, and therefore, potential is controlled from the sustain circuit 120.

Next, details of the respective driving waveforms (the P1 to the P4, the Pa) are explained. Similar waveforms are used in respective electrodes, for example, in the Fo of FIG. 1, the E1 and the E4 play the role of the sustain, and the E2 and the E3 play the role of the scan, and therefore, the same reference symbols are attached to the similar waveforms. A portion of the Tr 71 is characteristic.

### <Driving Waveform (1-1)>

First, in the Fo of FIG. 1, control is performed so that the E1 becomes the sustain electrode (x) and the E3 becomes the scan electrodes (y).

In the Tr 71, to the E2 and the E3, a reset pulse 31 having gradually increasing voltage is applied in a first period, and in a second period, an adjustment pulse 32 having gradually decreasing voltage is applied. And, to the E1 and the E4, a cathode reset pulse 41 is applied in the first period, and in the second period, an anode adjustment pulse 42 is applied. In the display line, a pair of the reset pulse 31 and the cathode reset pulse 41 functions as a charge accumulation pulse. And, a pair of the adjustment pulse 32 and the anode adjustment pulse 42 functions as a charge adjustment pulse. By the charge accumulation pulse and the charge adjustment pulse, in the Tr 71, the reset discharge is caused in the even-numbered display lines (Le), and no reset discharge is caused in the odd-numbered display lines (Lo) since the display electrodes have the same potential.

Then, in a Ta72, to E2 and E3 to be the scan electrodes, scan pulses 33a and 33b are applied at displaced timings in all the scan electrodes. Note that, with regard to such scan pulses, there are a method in which the scan pulse is applied from top to bottom only in the E2, and then the scan pulse is applied from top to bottom in the E3, in plural E2, E3 of the PDP 101 and a method in which the scan pulse is applied from top to bottom of the PDP 101 without distinction of the E2 and the E3, for example, and in the first embodiment, the former method is employed. Note that, the order of application of the scan pulse is not necessarily performed from top.

On the other hand, while the scan pulse 33a is applied to the E2, a sub-scan pulse 43a to be an anode is applied to the E1. And, while the scan pulse 33b is applied to the E3, a sub-scan pulse 43b to be an anode is applied to the E4. To the address electrode 21, address pulses 51 and 52 causing address discharge in display cells at intersection of the address electrode 21 and the scan electrodes (herein, E2, E3) are applied in synchronization with the scan pulses described above.

Then, in the next Ts 73, to the respective display electrodes, repetition of positive and negative sustain pulses is applied. To the E2 and the E3, a first positive sustain pulse 34 to be an anode is applied first. Then, a second negative sustain pulse 35 of repetition is applied, and thereafter, repetition pulses (34, 35) are applied with changing polarities alternately. Further, to the E1 and the E4, a first negative sustain pulse 44 to be a cathode is applied first, and in the same manner, then, a second positive sustain pulse 45 is applied, and thereafter, repetition pulses (44, 45) are applied with changing polarities alternately.

### <Driving Waveform (1-2)>

Next, in the Fe of FIG. 2, then, control is performed so that the E1 becomes the scan electrode (y) and the E3 becomes the sustain electrodes (x) using waveforms whose detail is similar with that of the Fo.

In the Tr 71, first of all, to the E1 and the E2, in the first period, a reset pulse 36 having gradually increasing voltage is applied, and in the second period, an adjustment pulse 37 having gradually decreasing voltage is applied. To the E3 and the E4, in the first period, a cathode reset pulse 46 is applied, and in the second period, an anode adjustment pulse 47 is applied. In the same manner as in the case of the Fo, in the display line, a pair of the reset pulse 36 and the cathode reset pulse 46 functions as a charge accumulation pulse. And, a pair of the adjustment pulse 37 and the anode adjustment pulse 47 functions as a charge adjustment pulse. By the charge accumulation pulse and the charge adjustment pulse, in the Tr 71, the reset discharge is caused in the odd-numbered display lines (Lo), and no reset discharge is caused in the even-numbered display lines (Le) since the display electrodes have the same potential.

Then, in the next Ta72, to the E1 and the E2, scan pulses 38a and 38b are applied at displaced timings in all the scan electrodes. On the other hand, while the scan pulse is applied to the E1, a sub-scan pulse 48a to be an anode is applied to the E4. While the scan pulse is applied to the E2, a sub-scan pulse 48b to be an anode is applied to the E3. To the address electrode 21, address pulses 56 and 57 causing address discharge in cells at intersection of the address electrode 21 and the scan electrode are applied in synchronization with the scan pulses. In the next Ts 73, to the E1 and the E2, a first positive sustain pulse 39 is applied first, then, a negative sustain pulse 40 is applied. In the same manner, while polarities are changed alternately, the pulses (39, 40) are applied repeatedly. On the other hand, to E3 and E4, the first sustain pulse 49 is applied, furthermore, a second positive sustain pulse 50 is applied, then, repetition pulses (49, 50) are applied with changing polarities alternately in the same manner.

### <Driving Waveform (1-3)>

Next, operation by the above respective driving waveforms is explained. In the Fo, in the Tr 71, in the display cells of the even-numbered display lines (Le) in which the charge accumulation pulse, that is, the reset pulse 31 and the cathode reset pulse 41 are applied to two adjacent display electrodes, slight discharge (writing reset discharge) occurs repeatedly, and a negative wall charge is formed at the vicinity of the scan electrodes (E2, E3), and a positive wall charge is formed at the vicinity of the sustain electrode (E1, E4). At this time, a positive wall charge is formed also at the vicinity of the address electrode 21. In the display cells of the odd-numbered display lines (Lo), no writing reset electrical discharge occurs since the adjacent two display electrodes have the same potential. Next, in the display cells of the even-numbered display lines (Le) in which the charge adjustment pulse, that is, the adjustment pulse 32 and the anode adjustment pulse 42 are applied to adjacent two display electrodes, a voltage of the wall electric charge is superimposed to the applied voltage, and slight discharge (adjustment reset discharge) occurs repeatedly. As a result, the negative wall charge at the vicinity of the scan electrodes (E2, E3) and the positive wall charge at the vicinity of the sustain electrodes (E1, E4) is decreased and adjusted. At this time, also the positive wall charge at the vicinity of the address electrode 21 is decreased and adjusted.

In the next Ta72, address discharge occurs by the above scan pulse and the address pulse, and further, it shifts to discharge between the scan electrodes (E2, E3) and the sustain electrodes (E1, E4). A positive wall charge is formed at the vicinity of the scan electrodes (E2, E3), and a negative wall electric charge is formed at the vicinity of the sustain electrodes (E1, E4), and display cells to emit light (lighting objectives) are memorized. In this address discharge, the wall charge formed at the vicinity of the respective electrodes in the Tr 71 is of the same polarity as that of a driving waveform applied to each electrode in the address discharge, and assists the discharge.

In the next Ts 73, only in the display cells memorized by forming the wall charge by the address discharge of the Ta 72, the sustain discharge is caused utilizing the wall charge.

Moreover, in the Fe, in the Tr 71, slight discharge (writing reset discharge) occurs repeatedly in the display cells of the odd-numbered display lines (Lo) in which the charge accumulation pulse, that is, the reset pulse 36 and the cathode reset pulse 46 are applied to adjacent two display electrodes, and a negative wall charge is formed at the vicinity of the scan electrodes (E1, E2) and a positive wall electric charge is formed at the vicinity of the sustain electrode (E3, E4). At this time, a positive wall charge is formed also at the vicinity of the address electrode 21. In the display cells of the even-numbered display lines (Le), since adjacent two display electrodes have the same potential, no writing reset discharge occurs. Thereafter, in the display cells of the odd-numbered display lines (Lo) in which the charge adjustment pulse, that is, the adjustment pulse 37 and the anode adjustment pulse 47 are applied to adjacent two display electrodes, a voltage of the wall charge is superimposed to the applied voltage, and slight discharge (adjustment reset discharge) occurs repeatedly. As a result, the negative wall charge at the vicinity of the scan electrodes (E1, E2) and the positive wall charge at the vicinity of the sustain electrodes (E3, E4) is decreased and adjusted. At this time, also the positive wall charge at the vicinity of the address electrode 21 is decreased and adjusted.

In the next Ta72, address discharge occurs by the above scan pulse and the address pulse, and further, it shifts to discharge between the scan electrodes (E1, E2) and the sustain electrodes (E3, E4). A positive wall charge is formed at the vicinity of the scan electrodes (E1, E2), and a negative wall charge is formed at the vicinity of the sustain electrodes (E3, E4), and the display cells to emit light are memorized. In this address discharge, the wall charge formed at the vicinity of the respective electrodes in the Tr 71 is of the same polarity as that of a driving waveform applied to each electrode in the address discharged, and assists the discharge.

In the next Ts 73, only in the display cells memorized by forming the wall charge in the address discharge of the Ta72, the sustain discharge is caused utilizing the wall charge.

Note that, as design of a driving waveform (voltage) to display lines to be non-objectives of the reset discharge, in addition to an embodiment in which the above same potential is obtained by applying similar waveforms to the relevant display electrode pair, design in which a voltage smaller than a discharge starting voltage is obtained between the relevant display electrodes by applying similar waveforms and the like can be employed.

By the above drive waveforms (the P1 to the P4), in the Fo, the even-numbered display lines (Le) become the lighting display lines, and in the Fe, the odd-numbered display lines (Lo) become the lighting display lines, and the reset discharge occurs. And in the Fo, the odd-numbered display lines (Lo) become the non-lighting display lines, and in the Fe, the even-numbered display lines (Le) become the non-lighting display lines, and no reset discharge occurs.

As explained above, according to the first embodiment, since wasteful light emission can be reduced by performing no reset to the display cells in the odd-numbered/even-numbered non-lighting display lines in the PDP 101, the background luminance is reduced and the contrast can be improved.

### Second Embodiment

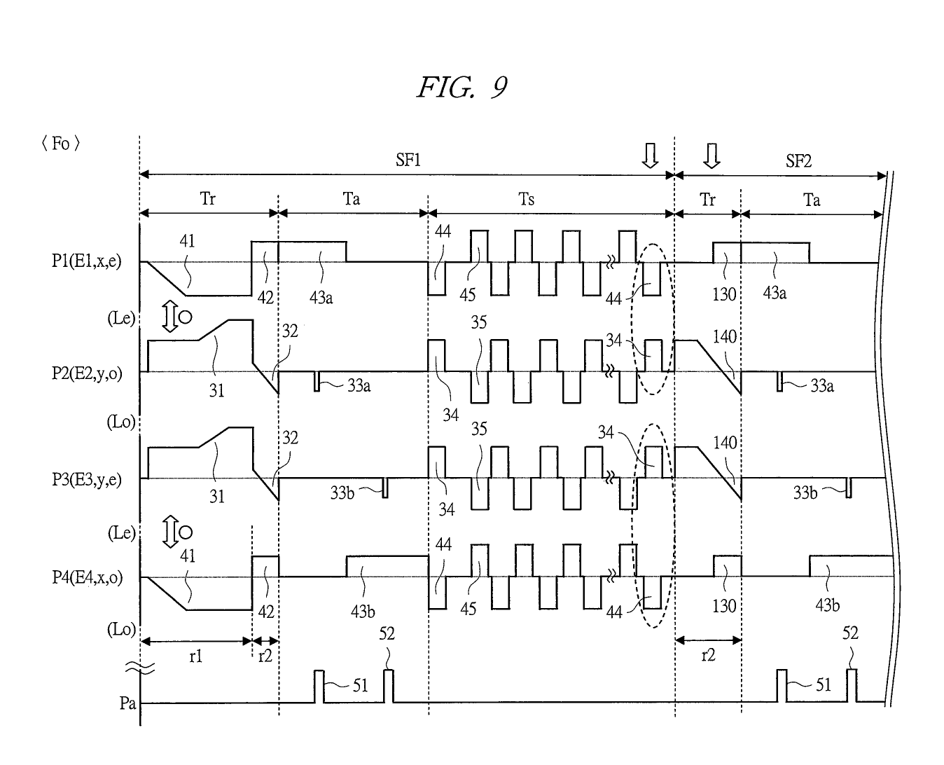

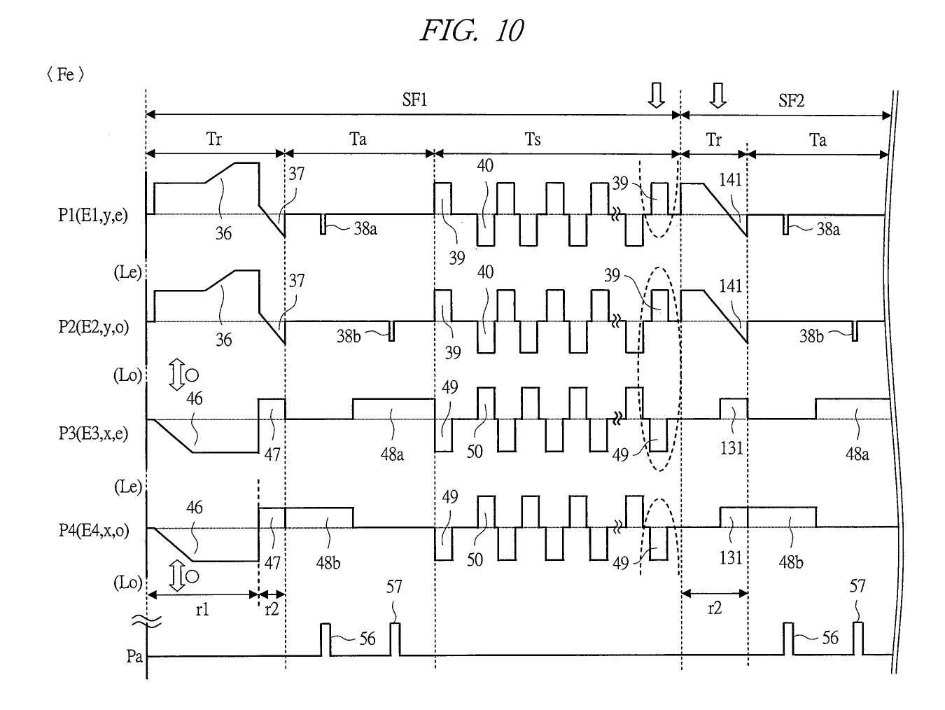

Next, a second embodiment is explained with reference to FIG. 9, FIG. 10 and FIG. 11. The second embodiment has a feature that in addition of the normal reset operation (first type reset operation) that is the feature of the first embodiment, on-cell reset operation is added as second type reset operation. As for the structure of the PDP 101, the circuit structure of the PDP apparatus, the structure of the field 60 and the like are the same as those in the first embodiment.

In FIG. 11, lighting objectives by the interlace driving at respective SF 70 in Fo and Fe in the second embodiment, and display lines to be first type and second type reset objects are shown. The display electrodes causing the above sustain scan (Vy) are E1, E3, and the display electrode causing the scan (y) is E2, and the display electrode causing the sustain (x) is E4. For each of the Fo and the Fe, control is performed so that normal reset (white circle) is carried out at the head SF 70 (“SF1”), and in the following SFs 70 (“SF2” to “SF10”), on-cell reset (black circle) is carried out.

Note that, a timing and objective SFs 70 of this reset operation are just one example, and in the reset operation in SFs 70 (“SF2” to “SF10”) other than the head SF 70 (“SF 71”), the normal reset can be selected. That is, it is free to select and combine the on-cell reset and the normal reset in each case.

In FIG. 9 and FIG. 10, driving waveforms (P1 to P4) corresponding to the respective display electrodes (E1 to E4) are explained. The last of Ts 73 in SF 70 and a portion of Tr 71 following the same are characteristics. In the second embodiment, for the on-cell reset, in a last sustain pulse pair of the Ts 73, for charge adjustment, that is, for making closer to a waveform in a normal first period (r1) in the next Tr 71, it is set to end by sustain pulses of positive/negative. As a result, the waveforms (41, 31) of a normal first period (r1) of the next Tr 73 can be thinned out.

In the Fo of FIG. 9, the E1 and the E4 play a role of sustain (x), and the E2 and the E3 play a role of scan (y). Pa is a driving waveform applied to the address electrode 21.

First, in the Tr 71 of the first SF 70 (“SF1”) of the Fo, in the same manner as the first embodiment, in correspondence to the first period (r1) and the second period (r2), to the E2 and the E3, the reset pulse 31 and the adjustment pulse 32 are applied. To the E1 and the E4, the cathode reset pulse 41 and the anode adjustment pulse 42 are applied. That is, the reset discharge is performed in each Le.

In the next Ta72, to the E2 and the E3, scan pulses 33a and 33b are applied at displaced timings in all the scan electrodes. On the other hand, while the scan pulse as described above is applied to the E2, a sub-scan pulse 43a to be an anode is applied to the E1. While the scan pulse as described above is applied to the E3, a sub-scan pulse 43b to be an anode is applied to the E4. To the address electrode 21, address pulses 51 and 52 causing address discharge in cells at intersection of the address electrode 21 and the scan electrodes are applied in synchronization with the respective scan pulses.

In the next Ts 73, to the E2 and the E3, the first positive sustain pulse 34 is applied, then, the negative sustain pulse 35 is applied, and the pulses (34, 35) are applied with changing polarities alternately in the same manner. On the other hand, to the E1 and the E4, the first negative sustain pulse 44 is applied, then, the positive sustain pulse 45 is applied, and the pulses (44, 45) are applied with changing polarities alternately in the same manner.

Herein, at the end of the Ts 73, as sustain pulses immediately before entering the Tr 71 of the next “SF2”, to the E1 and the E4, the negative sustain pulse 44 is applied, and to the E2 and the E3, the positive sustain pulse 34 is applied. By ending the discharge of the Ts 73 by this pulse pair (44, 34), a reset pulse 31 to be applied to the E2 and the E3 in the Tr 71 of the next SF 70 (“SF2”) and a cathode reset pulse 41 to be applied to the E1 and the E4 can be thinned out. That is, the charge accumulation pulse applied in the first period (r1) of the Tr 71 in the normal reset operation can be thinned out. As a result, in the next SF 70 (“SF2”), reset is performed only to the display lines and cells lighted in the SF 70 (“SF1”) just before. That is, in the reset operation (on-cell reset) at the next SF 70 (“SF2”), to the E1 and the E4, the anode adjustment pulse (on-cell anode adjustment pulse) 130 is applied, and to the E2 and the E3, an adjustment pulse having gradually decreasing voltage (on-cell adjustment pulse) 140 is applied. After that, the same operation is carried out in each SF 70.

As operation by the driving waveforms at the Fo, in the Fo of FIG. 9, in the Tr 71, slight discharge (writing reset discharge) is repeatedly caused in the cells of the even-numbered display lines (Le) in which the reset pulse 31 and the cathode reset pulse 41 are applied to two display electrodes, and a negative wall charge is formed at the vicinity of the scan electrodes (E2, E3) and a positive wall charge is formed at the vicinity of the sustain electrodes (E1, E4). At this time, a positive wall charge is formed also at the vicinity of the address electrode 21. In the cells of the odd-numbered display lines (Lo), since the two display electrodes have the same potential, writing reset discharge is not caused. Thereafter, in the cells of the even-numbered display lines (Le) in which the adjustment pulse 32 and the anode adjustment pulse 42 are applied to two display electrodes, a voltage of the wall charge is superimposed to the applied voltage, and slight discharge (adjustment reset discharge) is caused repeatedly. As a result, the negative wall charge at the vicinity of the scan electrodes (E2, E3) and the positive wall charge at the vicinity of the sustain electrodes (E1, E4) is decreased and adjusted. At this time, also the positive wall charge at the vicinity of the address electrode 21 is decreased and adjusted.

In the next Ta72, address discharge occurs by the scan pulse and the address pulse, and further, it shifts to discharge between the scan electrodes (E2, E3) and the sustain electrodes (E1, E4), a positive wall charge is formed at the vicinity of the scan electrodes (E2, E3), a negative wall charge is formed at the vicinity of the sustain electrodes (E1, E4) and cells to emit light are memorized. In this address discharge, the wall charges formed at the vicinity of the respective electrodes in the Tr 71 are of the same polarity as that of the driving waveforms applied to each electrode at the address discharge, and assist the discharge. In the next Ts 73, in only cells in which the wall charge is formed by the address discharge, sustain discharge occurs by use of the wall charge.

As operation of the on-cell reset, the last sustain pulse pair in the cells that light plays a role of the charge accumulation pulses (31+41) in the Tr 71, and a negative wall charge is formed at the vicinity of the scan electrodes (E2, E3) and a positive wall charge is formed at the vicinity of the sustain electrodes (E1, E4). For example, the last negative sustain pulse 44 of the Ts 73 and a cathode reset pulse 41 in the first period (r1) of the Tr 71 are of similar waveforms. Since two electrodes are of the same potential in the cells of the odd-numbered display lines (Lo), the writing reset discharge is not caused. Then, in the cells of the even-numbered display lines (Le) in which the charge adjustment pulses (140+150) are applied to two electrodes, a voltage of the wall charge is superimposed to the applied voltage and slight discharge (adjustment reset discharge) occurs repeatedly only in the cells that are lighted in the previous SF70. As a result, the negative wall charge at the vicinity of the scan electrodes (E2, E3), and the positive wall charge at the vicinity of the sustain electrodes (E1, E4) decrease and is adjusted. At this time, also the positive wall charge at the vicinity of the address electrode 21 decreases and is adjusted.

And, in the Fe of FIG. 10, in the same concept as in the Fo, control is performed so that the E3 and the E4 play the role of the sustain (x) and the E1 and the E2 play the role of the scan (y). First, in the Tr 71, to the E1 and the E2, the reset pulse 36 and the adjustment pulse 37 are applied. To the E3 and the E4, the cathode reset pulse 46 and the anode adjustment pulse 47 are applied. In the next Ta 72, to the E1 and the E2, the scan pulses 38a and 38b are applied at displaced timings in all the scan electrodes. On the other hand, to the E4, a sub-scan pulse 48b to be an anode is applied, while the scan pulse is applied to the E1. To the E3, a sub-scan pulse 48a to be an anode is applied, while the scan pulse is applied to the E2. To the address electrode 21, address pulses 56 and 57 causing address discharge in the cells at intersection of the address electrode 21 and the scan electrodes are applied in synchronization with the scan pulse.

In the next Ts 73, to the E1 and the E2, the first positive sustain pulse 39 is applied, then, the negative sustain pulse 40 is applied, and the pulses (39, 40) are applied repeatedly with polarities switched alternately in the same manner. On the other hand, to the E3 and the E4, the first negative sustain pulse 49 is applied, then, the positive sustain pulse 50 is applied, and the pulses (49, 50) are applied with polarities switched alternately in the same manner.

In the Ts 73, for the on-cell reset, as the sustain pulse immediately before entering the next “SF2”, to the E3 and the E4, the negative sustain pulse 49 is applied, and to the E1 and the E2, the positive sustain pulse 39 is applied. By ending the discharge of the Ts 73 by this pulse pair (49, 39), the reset pulse 36 to be applied to the E1 and the E2 and the cathode reset pulse 46 to be applied to the E3 and the E4 in the next Tr 71 can be thinned out, and as a result, the reset is made only to the cells of the display lines lighted in the just before “SF1” in the next “SF2”. In the reset at the Tr 73 of the “SF2”, to the E3 and the E4, an anode adjustment pulse 131 is applied, and to the E1 and the E2, an adjustment pulse 141 having gradually decreasing voltage is applied.

The operation by the driving waveforms at the Fe is in the same concept as that of the operation at the Fo. At the Fe, the last sustain pulse pair in the cells lighted plays the roles of the reset pulse 36 and the cathode reset pulse 46 at the Tr 71, and a negative wall charge is formed at the vicinity of the scan electrodes (E1, E2) and a positive wall charge is formed at the vicinity of the sustain electrodes (E3, E4). Since two display electrodes are of the same potential in the cells of the even-numbered display lines (Le), the writing reset discharge is not caused. Then, in the cells of the odd-numbered display lines (Lo) in which the adjustment pulse 141 and the anode adjustment pulse 131 are applied to two display electrodes, the voltage of the wall charge is superimposed to the applied voltage, and slight discharge (adjustment reset discharge) occurs repeatedly only in the cells lighted in the previous SF 70. As a result, the negative wall charge at the vicinity of the scan electrodes (E1, E2) and the positive wall charge at the vicinity of the sustain electrodes (E3, E4) decrease and is adjusted. At this time, also the positive wall charge at the vicinity of the address electrode 21 decreases and is adjusted.

By the above drive waveforms (the P1 to the P4), in the Fo, the even-numbered display lines (Le) become the lighting display lines to be lighted and reset, and in the Fe, the odd-numbered display lines (Lo) become the lighting display lines to be lighted and reset. And in the Fo, the odd-numbered display lines (Lo) become non-lighting display lines and no reset discharge occurs, and in the Fe, the even-numbered display lines (Le) become the non-lighting display lines and no reset discharge occurs.

As explained above, according to the second embodiment, in addition to reducing the background luminance in the same manner as in the first embodiment, the driving time can be shorten by thinning out a part of waveforms by the on-cell reset and the like.

### Third Embodiment

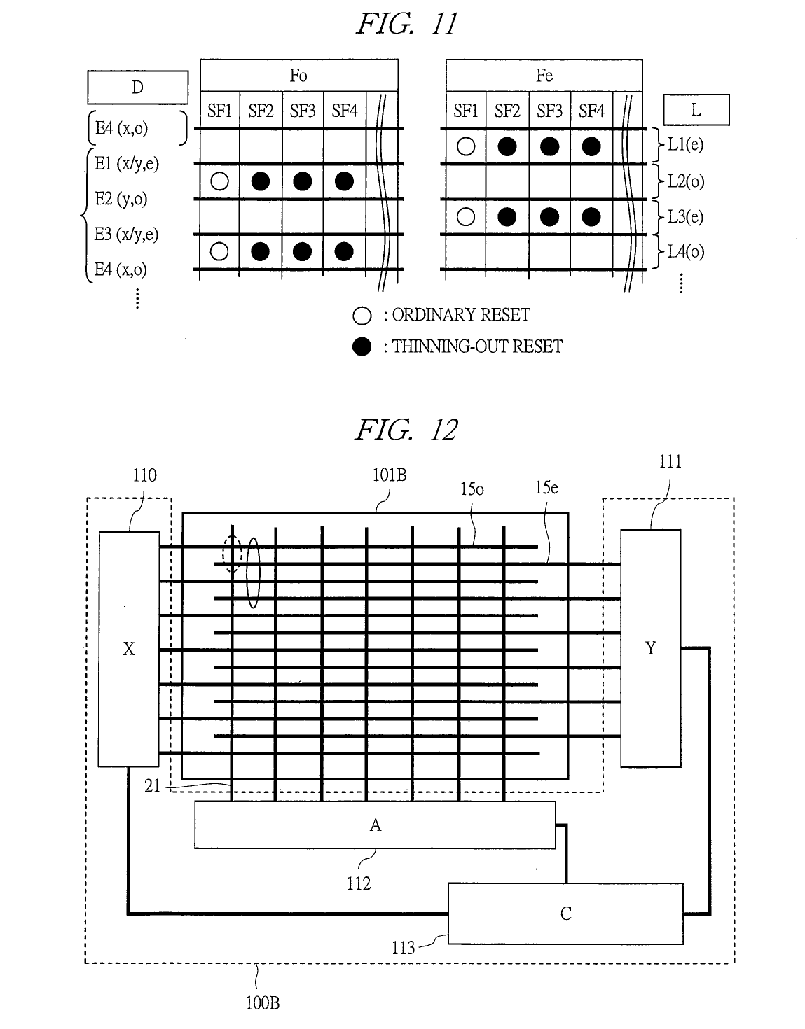

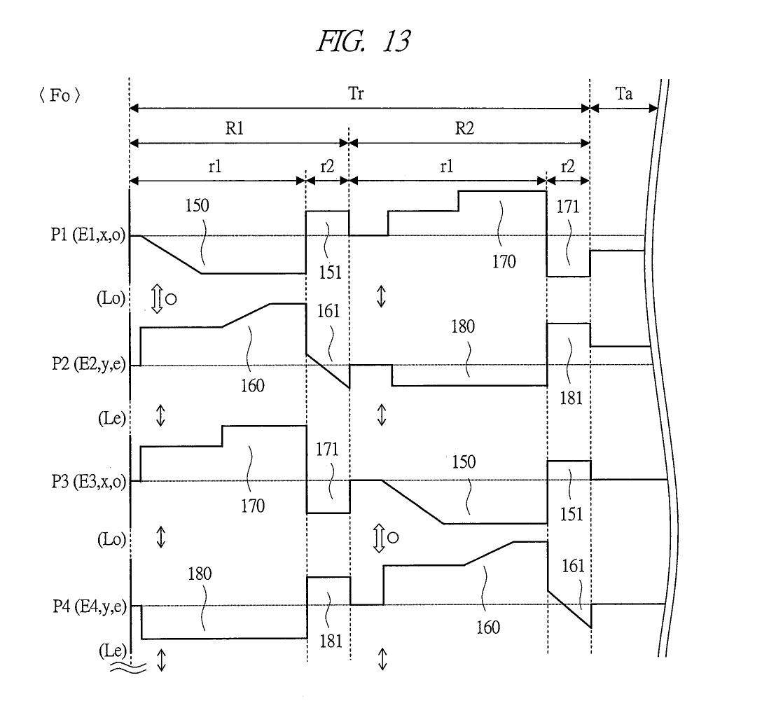

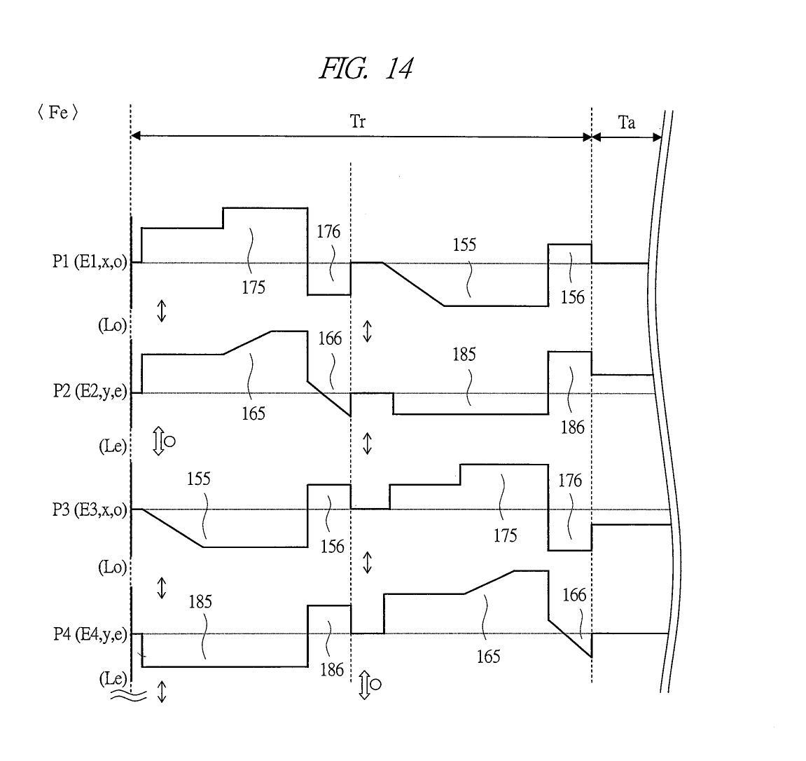

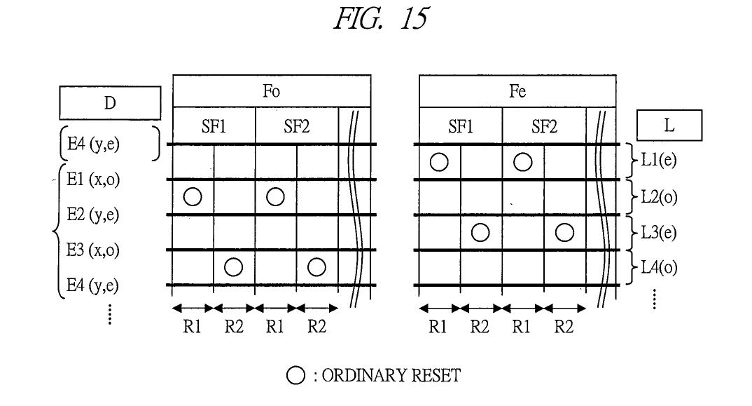

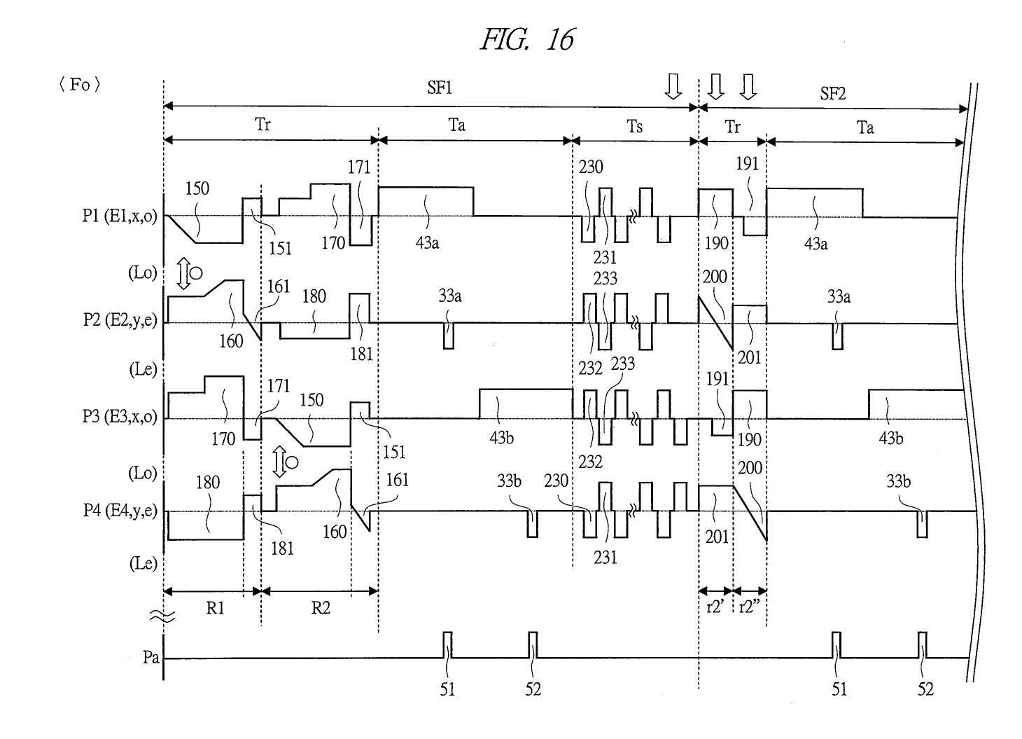

Next, a third embodiment is explained with reference to FIG. 12, FIG. 13, FIG. 14 and FIG. 15. The third embodiment has a feature that, in addition to the normal reset operation (the first type reset operation) that is the feature of the first embodiment, on-cell reset operation is added as the second type reset operation. The structure (second structure) of the PDP 101, the structure of the field 60 and the likes are the same as those in the first embodiment.

FIG. 12 shows a schematic structure of the PDP apparatus according to the third embodiment. A PDP 101B has the same structure as that of the PDP 101 shown in FIG. 3 (Note that, a role of the display electrode is different from that in the first embodiment). As a circuit structure of the PDP apparatus, a circuit unit 100B includes a control circuit 113, an address drive circuit 112, a sustain circuit (X) 110 and a scan circuit (Y) 111.

The sustain circuit 110 is a drive circuit for controlling display electrodes to play a role as the sustain electrode. The scan circuit 111 is a drive circuit for controlling display electrodes to play a role as the scan electrode.

As for respective display electrodes (E) of the PDP 101B, electrodes (first type electrodes: Ex) for sustain (x) connected with the sustain circuit 110 and electrodes (second type electrodes: Ey) for scan (y) connected with the scan circuit 111 are arranged alternately and repeatedly. Further, this PDP 101B has a display electrode connected with the sustain circuit 110 as a first display electrode (D1) at the most upper portion of the whole display lines in order to form display lines at both sides of the display electrode for scan (y).

FIG. 15 shows lighting display lines, cells and reset objectives in each SF 70. In the third embodiment, control is performed in the same manner in all the SFs 70 (without the on-cell reset). In the display electrodes (E), the E1 and the E3 are for sustain (x), and the E2 and the E4 are for scan (y). In the whole display electrodes (D), the scan electrodes (E2, E4) are arranged in the (2N)-th lines, and the sustain electrodes (E1, E3) are arranged in the (2N−1)-th lines. The first and last display electrodes (D) are sustain electrodes. In correspondence to the interlace driving, in the Fo, the odd-numbered display lines (Lo) become the lighting display lines, and in the Fe, the even-numbered display lines (Le) become the lighting display lines. And in the Fo, the even-numbered display lines (Le) become non-lighting display lines and no reset discharge occurs, and in the Fe, the odd-numbered display lines (Lo) become non-lighting display lines and no reset discharge occurs. In two-stage control by two periods (R1, R2) in the Tr 71, for example, the reset discharge is caused in a half of the odd-numbered display lines (Lo) in the Fo (for example, L2, L6, . . . ) first, and then, the reset discharge is caused in the remaining half (for example, L4, L8, . . . ).

In FIG. 13 and FIG. 14, as driving waveforms showing a driving method of the third embodiment, a portion of the Tr 71 is especially shown (although the reference symbols are the same as those in the embodiments mentioned previously, waveforms are different). Driving waveforms (P1 to P4) corresponding to display electrode groups (E1 to E4) in which two types of display electrodes (D) composed of odd-numbered ones for sustain (x, o) and even-numbered ones for scan (y, e) are arranged alternately as shown in FIG. 15 and driving waveform (Pa) of the address electrode 21 are shown.

The E1 and the E3 are connected with the sustain circuit 110, and the E2 and the E4 are connected with the scan circuit 111. And, since the driving waveforms applied to the respective SFs 70 are basically the same, one example of the typical driving waveforms in the Fo and the Fe is explained.

In the third embodiment, reset operation by wall charge control of two-stages of at the first period (R1) and the second period (R2) in the Tr 71 is carried out.

In the Tr 71 of the Fo in FIG. 13, at the first period (R1), to the E2, a reset pulse 160 having gradually increasing voltage is applied, and to the E1, an adjustment pulse (cathode reset pulse) 150 having gradually decreasing voltage is applied. And meanwhile, to the E3, a reset discharge avoidance positive pulse 170 to be almost the same potential as the E2 is applied, and to the E4, a reset discharge avoidance negative pulse 180 to be almost the same potential as the E1 is applied, respectively.

In operation by these pulses, between the E1 and the E2, in the cells of the odd-numbered display lines (Lo) in which the reset pulse 160 and the cathode reset pulse 150 are applied to two display electrodes, slight discharge (writing reset discharge) is repeatedly caused, and a negative wall charge is formed at the vicinity of the scan electrode (E2) and a positive wall charge is formed at the vicinity of the sustain electrode (E1). Thereby, the reset between E3-E4, E2-E3 and E4-E1 while performing the reset between E1-E2 can be prevented.

In the second period (r2) of the first period (R1), an anode adjustment pulse 151 is applied to the E1, an adjustment pulse 161 is applied to the E2, a reset adjustment avoidance negative pulse 171 is applied to the E3 and a reset adjustment avoidance positive pulse 181 is applied to the E4, respectively.

In the second period (R2) of the following Tr 71, in order to reset between the E3 and the E4, to the E4, a reset pulse 160 having gradually increasing voltage is applied, and to the E3, a reset pulse 150 having gradually decreasing voltage is applied. In order to cause no reset between E1-E2 and E2-E3, to the E2, a reset discharge avoidance negative pulse 180 to be almost the same potential as the E3 is applied, and to the E1, a reset discharge avoidance positive pulse 170 to be almost the same potential as the E4 is applied, respectively.

In operation by these pulses, between the E3 and the E4, in the cells of the odd-numbered display lines (Lo) in which the reset pulse 160 and the cathode reset pulse 150 are applied to two display electrodes, slight discharge (writing reset discharge) is repeatedly caused, and a negative wall charge is formed at the vicinity of the scan electrode (E4) and a positive wall charge is formed at the vicinity of the sustain electrode (E3). Thereby, the reset between E1-E2, E2-E3 and E4-E1 while performing the reset between E3-E4 can be prevented.

In the second period (r2) of the second period (R2), the reset adjustment avoidance negative pulse 171 is applied to the E1, the reset adjustment avoidance positive pulse 181 is applied to the E2, the anode adjustment pulse 151 is applied to the E3, and the adjustment pulse 161 is applied to the E4, respectively.

And, in the Tr 71 of the Fe of FIG. 14, the reset pulse 165 having gradually increasing voltage is applied to the E2, and the adjustment pulse 155 having gradually decreasing voltage is applied to the E3, respectively. Meanwhile, the reset discharge avoidance negative pulse 185 to be almost the same potential as the E3 is applied to the E4, and the reset discharge avoidance positive pulse 175 to be almost the same potential as the E2 is applied to the E1, respectively.

In operation by these pulses, between the E2 and the E3, in the cells of the even-numbered display lines (Le) in which the cathode reset pulse 155 and the reset pulse 165 are applied to two display electrodes, slight discharge (writing reset discharge) is repeatedly caused, and a negative wall charge is formed at the vicinity of the scan electrode (E2) and a positive wall charge is formed at the vicinity of the sustain electrode (E3). Thereby, the reset between E1-E2, E3-E4, and E4-E1 while performing the reset between E2-E3 can be prevented.

In the second period (r2) of the first period (R1), the reset adjustment avoidance negative pulse 176 is applied to the E1, the adjustment pulse 166 is applied to the E2, the anode adjustment pulse 156 is applied to the E3, and the adjustment pulse 186 is applied to the E4, respectively.

In the second period (R2) of the following Tr 71, in order to reset between the E4 and the E1, to the E4, the reset pulse 165 having gradually increasing voltage is applied, to the E1, the adjustment pulse 155 having gradually decreasing voltage is applied, to the E2, the reset discharge avoidance negative pulse 185 to be almost the same potential as the E1 is applied, and to the E3, the reset discharge avoidance positive pulse 175 to be almost the same potential as the E4 is applied, respectively.

In operation by these pulses, between the E4 and the E1, in the cells of the even-numbered display lines (Le) in which the reset pulse 165 and the cathode reset pulse 155 are applied to two display electrodes, slight discharge (writing reset discharge) is repeatedly caused, and a negative wall charge is formed at the vicinity of the scan electrode (E4) and a positive wall charge is formed at the vicinity of the sustain electrode (E1). Thereby, the reset between E1-E2, E2-E3 and E3-E4 while performing the reset between E4-E1 can be prevented.

In the second period (r2) of the second period (R2), the anode adjustment pulse 156 is applied to the E1, the reset adjustment avoidance negative pulse 186 is applied to the E2, the reset adjustment avoidance negative pulse 176 is applied to the E3, and the adjustment pulse 166 is applied to the E4, respectively.

By the above drive waveforms, in the Fo, the odd-numbered display lines (Lo) become the lighting display lines, and in the Fe, the even-numbered display lines (Le) become the lighting display lines and reset discharge is caused in the respective lighting display lines. And in the Fo, the even-numbered display lines (Fe) become the non-lighting display lines, and in the Fe, the odd-numbered display lines (Lo) become the non-lighting display lines and no reset discharge is caused.

As explained above, according to the third embodiment, by performing no reset in the display cells in the non-lighting display lines of even-numbered/odd-numbered, wasteful light emission can be reduced, and therefore, background luminance can be reduced and the contrast can be improved.

### Fourth Embodiment

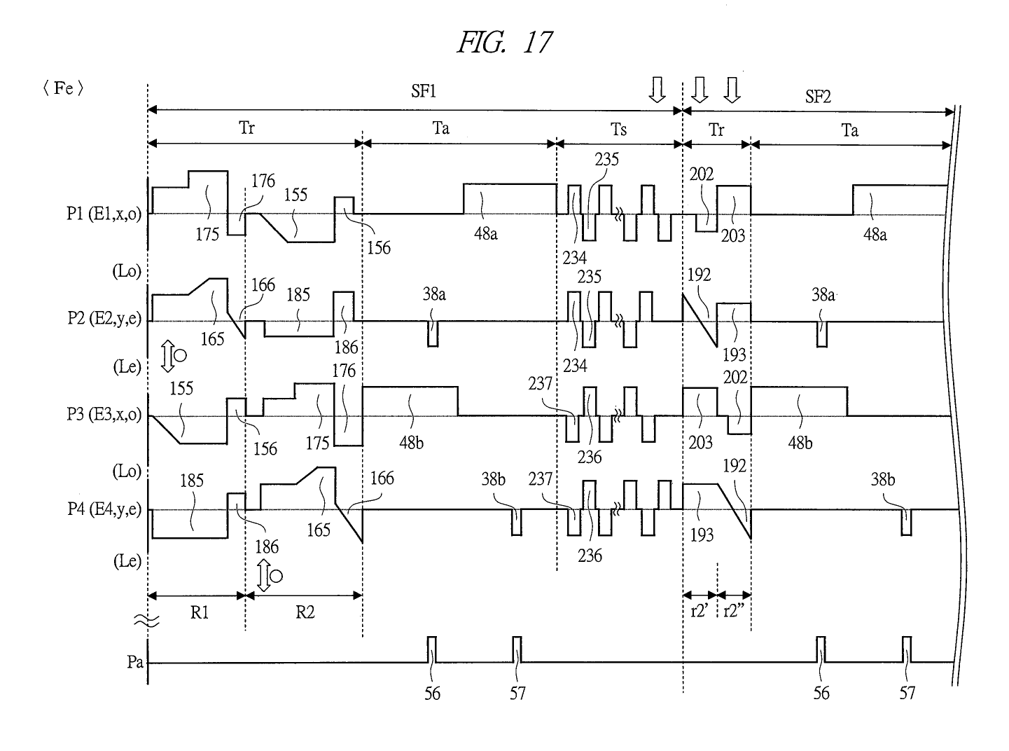

Next, a fourth embodiment is explained with reference to FIG. 16 and FIG. 17. The fourth embodiment has a feature that both of characteristics of the second and third embodiments are provided. The structure (second structure) of the PDP 101, the structure of the field 60 and the likes are the same as those in the first embodiment, and the circuit structure is the same as that of the third embodiment.

FIG. 16 and FIG. 17 show driving waveforms in a driving method according to the fourth embodiment. In the same manner as in the third embodiment, driving waveforms (P1 to P4) corresponding to the display electrode groups (E1 to E4) in which the sustain electrode (E1, E3) and the scan electrode (E2, E4) are arranged alternately are shown. The E1 and the E3 are connected with the sustain circuit 110, and the E2 and the E4 are connected with the scan circuit 111. And, since driving waveforms applied to respective SFs 70 in the fourth embodiment are basically the same, only one example of typical driving waveforms in the Fo and the Fe is explained.

First, in the Fo of FIG. 16, in the first period (R1) of the Tr 71, for reset between E1-E2 and non-reset in the others, the reset pulse 160 is applied to the E2 and the adjustment pulse 150 is applied to the E1. Meanwhile, to the E3, the reset discharge avoidance positive pulse 170 to be almost the same potential as the E2 is applied, and to the E4, the reset discharge avoidance negative pulse 180 to be almost the same potential as the E1 is applied. Thereafter, to the E1 to the E4, the respective pulses (151, 161, 171 and 181) are applied in the same manner as in the embodiments mentioned above. In the following second period (R2), for reset between E3-E4 and non-reset in the others, the reset pulse 160 is applied to the E4, and the adjustment pulse 150 is applied to the E3. To the E2, the reset discharge avoidance negative pulse 180 to be almost the same potential as the E3 is applied, and to the E1, the reset discharge avoidance positive pulse 170 to be almost the same potential as the E4 is applied. Thereafter, to the E1 to the E4, the respective pulses (171, 181, 151 and 161) are applied in the same manner as in the embodiments mentioned above.

In the next Ta 72, in the same manner as in the embodiments mentioned above, the scan pulses 33a, 33b, the sub-scan pulse 43a and the sub-scan pulse 43b are applied, and to the address electrode 21, the address pulses 51, 52 are applied.

In the next Ts 73, to the E2 and the E3, the pulses are applied repeatedly with polarities changed alternately, such as, the first positive sustain pulse 232, and then, the second negative sustain pulse 233. On the other hand, to the E1 and the E4, the pulses are applied repeatedly with polarities changed alternately, such as, the first negative sustain pulse 230, and then, the second positive sustain pulse 231. Then, in the last sustain pulse pair of the Ts 73 immediately before entering the Tr 71 of the next “SF2”, for the on-cell reset, to the E1 and the E3, the negative sustain pulse 230 is applied, and to the E2 and the E4, the positive sustain pulse 232 is applied.

By ending the discharge of the Ts 73 by this pulse pair, the charge accumulation pulses in the respective first periods (r1) in the next Tr 71, that is, two pairs of, the reset pulse 160 and the cathode reset pulse 150, and, the reset discharge avoidance negative pulse 180 and the reset discharge avoidance positive pulse 170, can be thinned out, and in the next SF 70, the reset is performed only to the display lines and cells that are lighted on just before.

In reset operation in the Tr 71 of the next “SF2”, in the first half part (r2′), to the E1, the anode adjustment pulse 190 is applied to the E1, the adjustment pulse 200 is applied to the E2, the reset adjustment avoidance positive pulse 201 to be almost the same potential as the E1 is applied to the E4, and, the reset adjustment avoidance negative pulse 191 to be almost the same potential as the E2 is applied to the E3, respectively. In the second half (r2″), the anode adjustment pulse 190 is applied to the E3, the adjustment pulse 200 is applied to the E4, the reset adjustment discharge avoidance negative pulse 191 to be almost the same potential as the E4 is applied to the E1, and the reset adjustment discharge avoidance positive pulse 201 to be almost the same potential as the E3 is applied to the E2. Afterwards, the same process is performed.

In operation by these pulses, in the same manner as in the embodiments mentioned above, in the R1 of the Tr 71, between the E1 and the E2, in the cells of the odd-numbered display lines (Lo), the writing reset discharge occurs, and while the reset is performed between E1-E2, the reset between the other display electrodes can be prevented. In the reset after that, between the E3 and the E4, in the cells of the odd-numbered display lines (Lo), the writing reset discharge occurs, and while the reset is performed between E3-E4, the reset between the other display electrodes can be prevented.

In the next Ta 72, the same address operation as that in the embodiments mentioned above is carried out. In the next Ts 73, only in the cells in which wall charge is formed by the address discharge, sustain discharge is caused by use of the wall charge. The last sustain pulse pair in the cells lighted play the roles of the reset pulse 160 and the cathode reset pulse 150 in the Tr 71, and a negative wall charge is formed at the vicinity of the scan electrodes (E2, E4) and a positive wall charge is formed at the vicinity of the sustain electrode (E1, E3). In the cells of the odd-numbered display lines (Le), since the two display electrodes have the same potential, the writing reset discharge is not caused. Then, in the cells of the odd-numbered display lines (Lo) in which the adjustment pulse 200 and the anode adjustment pulse 190 are applied to two display electrodes, voltage of the wall charge is superimposed to the applied voltage, and the adjustment reset discharge is caused repeatedly only in the cells lighted in the previous SF 70. Thereby, the negative wall charge at the vicinity of the scan electrodes (E2, E4) and the positive wall charge at the vicinity of the sustain electrodes (E1, E3) decrease and is adjusted. At this time, also the positive wall charge at the vicinity of the address electrode 21 decreases and is adjusted.

And, in the Fe of FIG. 17, in the Tr 71, the reset pulse 165 is applied to the E2 and the adjustment pulse 155 is applied to the E3, and meanwhile, the reset discharge avoidance positive pulse 175 to be almost the same potential as the E2 is applied to the E1 and the reset discharge avoidance negative pulse 185 to be almost the same potential as the E3 is applied to the E4. Thereafter, for reset between the E4 and the E1 and non-reset in the others, the reset pulse 165 is applied to the E4, the adjustment pulse 155 is applied to the E1, the reset discharge avoidance negative pulse 185 to be almost the same potential as the E1 is applied to the E2, and the reset discharge avoidance positive pulse 175 to be almost the same potential as the E4 is applied to the E3.

In the next Ta 72, in the same manner as in the embodiments mentioned above, the scan pulses 38a, 38b, the sub-scan pulse 48a and the sub-scan pulse 48b are applied. To the address electrode 21, the address pulses 56 and 57 are applied.

In the next Ts 73, to the E1 and the E2, pulses are applied repeatedly, such as the first positive sustain pulse 234, and then, the second negative sustain pulse 235. On the other hand, to the E3 and the E4, pulses are applied repeatedly, such as the first negative sustain pulse 237, and then, the second positive sustain pulse 236. As the sustain pulses just before entering the “SF2”, to the E1 and the E3, the negative sustain pulse 237 is applied, and to the E2 and the E4, the positive sustain pulse 234 is applied. By ending the discharge by this pulse pair, the reset pulse 165, the cathode reset pulse 155, the reset discharge avoidance negative pulses 185 and the reset discharge avoidance positive pulses 175 can be thinned out, and in the next SF 70, reset is performed only in the cells lighted in the just previous SF 70.

In reset operation in the “SF2”, in the first half (r2′), the anode adjustment pulse 203 is applied to the E3, the adjustment pulse 192 is applied to the E2, the reset adjustment avoidance positive pulse 193 to be almost the same potential as the E3 is applied to the E4, the reset adjustment avoidance negative pulse 202 to be almost the same potential as the E2 is applied to the E1, respectively. In the second half (r2″), the anode adjustment pulse 203 is applied to the E1, the adjustment pulse 192 is applied to the E4, the reset adjustment avoidance negative pulse 202 to be almost the same potential as the E4 is applied to the E3, and the reset adjustment avoidance positive pulse 193 to be almost the same potential as the E1 is applied to the E2, respectively.

In operation by these pulses, in the R1, between the E2 and the E3, in the even-numbered display lines (Le), the writing reset discharge occurs, and the reset between the other display electrodes while performing the reset between E2-E3 can be prevented. In the R2 after that, between the E4 and the E1, in the even-numbered display lines (Le), the writing reset discharge occurs, and the reset between the other display electrodes while performing the reset between E4-E1 can be prevented.

In the following Ta 72, the same address operation as that in the embodiments mentioned above is carried out. In the following Ts 73, the same sustain operation as that in the embodiments mentioned above is carried out. The last sustain pulse pair in the cells lighted plays the roles of the reset pulse 165 and the cathode reset pulse 155, and by the same operation as at the Fo, the amount of the wall charges at the vicinity of the respective electrode is adjusted.

As explained above, according to the fourth embodiment, effects by both of the second and the third embodiments can be obtained, and therefore, in addition to reduction of the background luminance and the like, the driving time can be shortened.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The present invention can be applied to a digital display apparatus such as a PDP apparatus.

1. A driving method of a plasma display panel comprising: a group of display electrodes arranged in parallel so as to extend in a first direction over a first plate and having discharge gaps formed between the electrodes adjacent at both sides in a second direction perpendicular to the first direction respectively; and a dielectric layer and a protective layer covering the group of display electrodes,
wherein the plasma display panel comprises: a group of address electrodes arranged over a second plate opposing the first plate so as to intersect with the group of display electrodes; a dielectric layer covering the group of address electrodes; second barrier ribs arranged at both sides of the group of address electrodes and extending in the second direction; first barrier ribs extending in the first direction so as to overlap with the display electrodes; and phosphor applied to a region between the first and the second barrier ribs,
wherein the plasma display panel is configured by sticking the first plate and the second plate together, display lines are formed by pairs of the display electrodes adjacent to each other and a display cell is formed in a region of intersection of the pair of the display electrodes and the address electrodes surrounded by the first and the second barrier ribs in a lattice shape,
wherein the method comprising the steps of:
lighting and displaying one of the odd-numbered and even-numbered display lines alternately by a field of the plasma display panel using an interlace driving method, and
wherein the pair of the display electrodes of only one of the odd-numbered and the even-numbered display lines to be an objective of the lighting and displaying is taken as an objective, reset operation to be preparation operation for addressing is performed by a driving waveform from a side of a drive circuit.

2. The driving method of a plasma display panel according to claim 1, further comprising the steps of:
providing a plurality of sub-fields dividing the field of the plasma display panel by grey scale, the sub-fields comprising a reset period, an address period and a sustain period; and
applying, in operation in the reset period, a pulse causing reset discharge to the pair of the display electrodes of one of the odd-numbered and even-numbered display lines to be the objective of the lighting and displaying, and applying a pulse causing no reset discharge to the pair of the display electrodes of the other of the odd-numbered and even-numbered display lines,
wherein at least in the head sub-field, in each of the odd-numbered and even-numbered fields, in the reset period, one of a same potential and a voltage smaller than a discharge starting voltage of the pair of the display electrodes is applied to the pair of the display electrodes of the other of the odd-numbered and even-numbered display lines not to be the objective of the lighting and displaying in the display lines.

3. The driving method of a plasma display panel according to claim 2,
wherein the group of display electrodes comprises:
first type electrodes for sustain having no scan pulse applied;
second type electrodes for scan having scan pulses applied; and
third type electrodes having the sustain and the scan performed selectively,
wherein the first type electrodes are arranged at 1st and (4N+1)-th orders, one of the second type electrodes is arranged at (4N−1)-th order and the second type electrodes are arranged at (4N)-th and (4N-2)-th orders, respectively, and
wherein in the third type electrodes, the (4N-2)-th display electrode is driven to play a role of the sustain in the odd-numbered field and driven to play a role of the scan in the even-numbered field, and the (4N)-th electrode is driven to play the role of the scan in the odd-numbered field and driven to play the role of the sustain in the even-numbered field.

4. The driving method of a plasma display panel according to claim 3,
wherein the driving waveform applied to the group of display electrodes in the reset period includes a pulse for charge accumulation in a first period and a pulse for charge adjustment in a second period following thereto, and
wherein in the sub-field other than the head sub-field in the field, only one of the odd-numbered and even-numbered display lines including a display cell lighted in the sub-field just before is taken as an objective and a sustain pulse pair causing pulse discharge for adjustment thinning out a pulse in the first period of a next reset period at end of the sustain period is applied to perform operation thinning out application of the pulse in the first period of the next reset period.

5. The driving method of a plasma display panel according to claim 2,
wherein the group of display electrodes is composed of:
first type electrodes for sustain having no scan pulse applied; and
second type electrodes for scan having a scan pulse applied, and
wherein the first type electrodes are arranged at (2N−1)-th and (2N+1)-th orders and one of the second type electrodes is arranged at {2N}-th order, respectively.

6. The driving method of plasma display panel according to claim 5,
wherein the driving waveform applied in the reset period includes a pulse for charge accumulation in a first period and a pulse for charge adjustment in a second period following thereto, and
wherein in the sub-field other than the head sub-field in the field, only one of the odd-numbered and even-numbered display lines including a display cell lighted in the sub-field just before is taken as an objective, a sustain pulse pair causing pulse discharge for adjustment thinning out a pulse in the first period of a next reset period at end of the sustain period is applied to perform operation thinning out application of the pulse in the first period of the next reset period.

7. A plasma display apparatus comprising:
a plasma display panel including:
a group of display electrodes arranged in parallel so as to extend in a first direction over a first plate and having discharge gaps formed between the electrodes adjacent at both sides in a second direction perpendicular to the first direction respectively; and
a dielectric layer and a protective layer covering the group of display electrodes,
wherein the plasma display panel includes: a group of address electrodes arranged over a second plate opposing the first plate so as to intersect with the group of display electrodes; a dielectric layer covering the group of address electrodes; second barrier ribs arranged at both sides of the group of address electrodes and extending in the second direction; first barrier ribs extending in the first direction so as to overlap with the display electrodes; and phosphor applied to a region between the first and the second barrier ribs, and
wherein the plasma display panel is configured by sticking the first plate and the second plate together, display lines are formed by pairs of the display electrodes adjacent to each other and a display cell is formed in a region of intersection of the pair of the display electrodes and the address electrodes surrounded by the first and the second barrier ribs in a lattice shape;
a first drive circuit applying a voltage to the group of display electrodes;
a second drive circuit applying a voltage to the group of address electrodes; and
a control circuit controlling the first and the second drive circuits,
wherein an interlace driving method lighting and displaying one of the odd-numbered and even-numbered display lines alternately by a field of the plasma display panel is used, and
wherein the pair of the display electrodes of only one of the odd-numbered and even-numbered display lines to be an objective of the lighting and displaying is taken as an objective, reset operation to be preparation operation for addressing is performed by driving the group of display electrodes by a driving waveform from a side of the first drive circuit.

8. The plasma display apparatus according to claim 7,
wherein a plurality of sub-fields dividing the field of the plasma display panel by grey scale is provided and the sub-fields comprise a reset period, an address period and a sustain period,
wherein in operation in the reset period, a pulse causing reset discharge is applied to the pair of the display electrodes of one of the odd-numbered and even-numbered display lines to be the objective of the lighting and displaying and a pulse causing no reset discharge is applied to the pair of the display electrodes of the other of the odd-numbered and even-numbered display lines, and
wherein at least in the head sub-field, in each of the odd-numbered and even-numbered fields, in the reset period, one of a same potential and a voltage smaller than a discharge starting voltage of the pair of the display electrodes is applied to the pair of the display electrodes of the other of the odd-numbered and even-numbered display lines not to be the objective of the lighting and displaying in the display lines.

9. The plasma display apparatus according to claim 8,
wherein the group of display electrodes comprises:
first type electrodes for sustain having no scan pulse applied;
second type electrodes for scan having scan pulses applied; and
third type electrodes having the sustain and the scan performed selectively,
wherein the first type electrodes are arranged at 1st and (4N+1)-th orders, one of the second type electrodes is arranged at {4N−1}-th order and the second type electrodes are arranged at (4N)-th and (4N−2)-th orders, respectively,
wherein the first drive circuit comprises a circuit driving the first type electrodes, a circuit driving the second type electrodes and a circuit driving the third type electrodes, and
wherein, in the third type electrodes, the (4N−2)-th display electrode is driven to play a role of the sustain in the odd-numbered field and driven to play a role of the scan in the even-numbered field, and the (4N)-th display electrode is driven to play the role of the scan in the odd-numbered field and driven to play the role of the sustain in the even-numbered field.

10. The plasma display apparatus according to claim 9,
wherein a driving waveform applied to the display electrodes in the reset period includes a pulse for charge accumulation in a first period and a pulse for charge adjustment in a second period following thereto, and
wherein in the sub-field other than the head sub-field in the field, only one of the odd-numbered and even-numbered display lines including a display cell lighted in the sub-field just before is taken as an objective, a sustain pulse pair causing pulse discharge for adjustment thinning out a pulse in the first period of a next reset period at end of the sustain period is applied to perform operation thinning out application of the pulse in the first period of the next reset period.

11. The plasma display apparatus according to claim 8,
wherein the display electrode comprises:
first type electrodes for sustain having no scan pulse applied; and
second type electrodes for scan having scan pulses applied,
wherein the first type electrodes are arranged at (2N−1)-th and (2N+1)-th orders and one of the second type electrodes is arranged at (2N)-th order, respectively, and
wherein the first drive circuit includes a circuit driving the first type electrodes and a circuit driving the second type electrodes.

12. The plasma display apparatus according to claim 11,
wherein a driving waveform applied in the reset period includes a pulse for charge accumulation in a first period and a pulse for charge adjustment in a second period following thereto, and
wherein in the sub-field other than the head sub-field in the field, only one of the odd-numbered and even-numbered display lines including a display cell lighted in the sub-field just before is taken as an objective, one of a positive sustain pulse and a negative sustain pulse causing pulse discharge for adjustment thinning out a pulse in the first period of a next reset period at end of the sustain period is applied to perform operation thinning out application of the pulse in the first period of the next reset period.
